(19) United States
(12) Patent Application Publication
(10) Pub. No.: US 2024/0241326 A1
(43) Pub. Date: Jul. 18, 2024

(54) OPTICAL MODULE

(71) Applicant: ams-OSRAM AG, Premstaetten (AT)

(72) Inventors: Victor SIDOROV, Graz (AT); Jesus CASTANO FERNANDO, Unterpremstätten (AT); Anderson SINGULANI, Graz (AT); Diana HOHL, Oberrieden (CH); Luca LUCERA, Adliswil (CH)

(21) Appl. No.: 18/289,628

(22) PCT Filed: Apr. 13, 2022
(86) PCT No.: PCT/EP2022/059958

§ 371 Date: Nov. 6, 2023

(30) Foreign Application Priority Data
May 6, 2021 (GB) 2106461.3

(51) Int. Cl. G02B 6/42

(52) U.S. Cl. CPC G02B 6/4214

(57) ABSTRACT

An optical module includes an emitter and a semiconductor device. The emitter is attached to the semiconductor device and is separated from the semiconductor device by a gap. The semiconductor device includes a waveguide and a diffraction grating located within semiconductor of the semiconductor device. The diffraction grating is a coupling diffraction grating configured to couple light emitted from the emitter into the waveguide. The semiconductor device further includes an additional diffraction grating which is provided on a surface of the semiconductor device which faces the emitter.

### TECHNICAL FIELD OF THE DISCLOSURE

The disclosure relates to an optical module and to a method of making an optical module.

### BACKGROUND OF THE DISCLOSURE

The present disclosure relates an optical module comprising an emitter attached to a semiconductor device, and to a method of making such an optical module.

Known optical modules comprise an emitter which is attached to but spaced apart from a semiconductor device. The emitter may for example be a vertical cavity surface emitting laser (VCSEL). The semiconductor device comprises a waveguide configured to guide light emitted by the emitter, and comprises an optical element used to couple the light from the emitter into the waveguide. The optical element may for example be a diffraction grating. The optical element may further comprise one or more sensors, or other electrical elements which sense or use light. Such an optical module may be referred to as a photonic integrated circuit (PIC) because it guides or manipulates light in a semiconductor device which may also include integrated electro-optical and/or electrical components.

A problem associated with known optical modules is that the light from the emitter may suffer from instability (e.g. fluctuation of intensity). In some cases the emitter may become damaged over time such that the optical module no longer functions correctly.

It is an aim of the present disclosure to address one or more of the problems above.

### SUMMARY

In general, this disclosure proposes to overcome the above problems by providing a diffraction grating on a surface of the semiconductor device which faces the emitter. The diffraction grating may be positioned above, and may have the same pitch as, a diffraction grating located within the semiconductor device. The diffraction grating on the surface of the semiconductor device may be referred to as a surface grating, and the diffraction grating within the semiconductor device may be referred to as a coupling grating (it may be configured to couple light for example into a waveguide). The surface grating may be a projection of the coupling grating, and may be formed via deposition of semiconductor material onto the coupling grating.

According to a first aspect of the invention there is provided an optical module comprising an emitter and a semiconductor device, the emitter being attached to the semiconductor device and being separated from the semiconductor device by a gap, wherein the semiconductor device comprises a waveguide and a diffraction grating located within semiconductor of the semiconductor device, the diffraction grating being a coupling diffraction grating configured to couple light emitted from the emitter into the waveguide, and wherein the semiconductor device further comprises an additional diffraction grating which is provided on a surface of the semiconductor device which faces the emitter.

Advantageously, the diffraction grating on the surface of the semiconductor device reduces or prevents back-reflection of light into the emitter.

The diffraction grating on the surface of the semiconductor device may have the same pitch as the coupling diffraction grating.

The diffraction grating on the surface of the semiconductor device may be aligned with the coupling diffraction grating.

The diffraction grating on the surface of the semiconductor device may be a projection of the coupling diffraction grating to the surface of the semiconductor device.

Raised portions of the diffraction grating on the surface of the semiconductor device may have sloping sides.

Lines of the coupling diffraction grating may have substantially vertical sides.

The emitter may be a laser.

The emitter may be a vertical cavity surface emitting laser (VCSEL).

The emitter may be configured to emit infrared light.

The semiconductor device may comprise a first semiconductor material and a second semiconductor material, the first semiconductor material having a higher refractive index than the second semiconductor material. The coupling diffraction grating and the waveguide may be formed from the first semiconductor material encased in the second semiconductor material. The diffraction grating on the surface of the semiconductor device may be formed from the second semiconductor material.

The first semiconductor material may be SiN. The second semiconductor material may be SiO₂.

The semiconductor device may further comprise integrated circuits and at least one electro-optic device.

According to a second aspect of the invention there is provided a method of forming an optical module comprising providing a layer of a second semiconductor material on top of a layer of a first semiconductor material, using lithography to etch a pattern into the second semiconductor material, the pattern comprising a coupling diffraction grating and a waveguide, using a deposition process to provide more of the first semiconductor material on top of the diffraction grating and waveguide, wherein an additional diffraction grating is formed on an upper surface of the first semiconductor surface, this surface diffraction grating being a projection of the coupling diffraction grating, and attaching an emitter to the semiconductor device, the emitter being separated from the semiconductor device by a gap.

The etching may pass through the second semiconductor material and etch into the first semiconductor material.

The surface diffraction grating may have the same pitch as the coupling diffraction grating.

The surface diffraction grating may be aligned with the coupling diffraction grating.

Raised portions of the surface diffraction grating may have sloping sides.

Lines of the coupling diffraction grating may have substantially vertical sides.

The first semiconductor material may be SiN. The second semiconductor material may be SiO₂.

Features of different aspects of the invention may be combined together.

Finally, the present display system disclosed here utilises a novel approach at least in that a surface grating is provided on top of a coupling grating of a semiconductor device, and prevents or reduces back-reflection of emitted light from the semiconductor device into the emitter.

### BRIEF DESCRIPTION OF THE PREFERRED EMBODIMENTS

Some embodiments of the disclosure will now be described by way of example only and with reference to the accompanying drawings, in which:

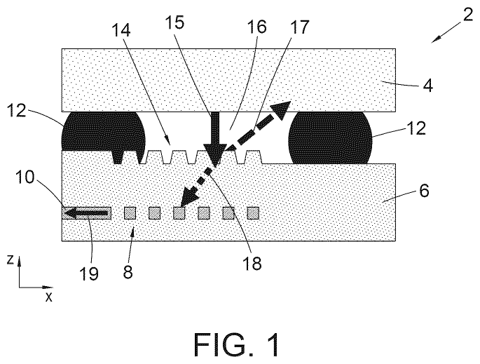

FIG. 1 schematically depicts in cross section an optical module according to an embodiment of the disclosure;

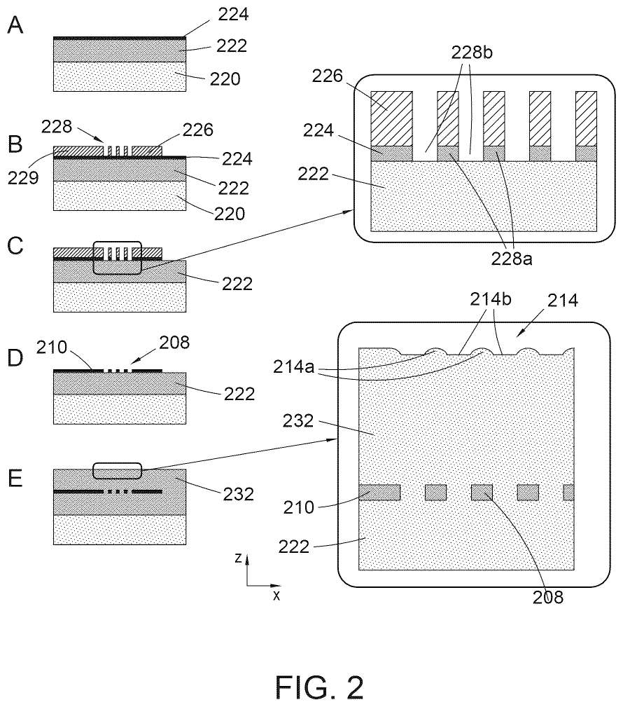

FIG. 2 schematically depicts a method of fabricating a semiconductor device of the module depicted in FIG. 1;

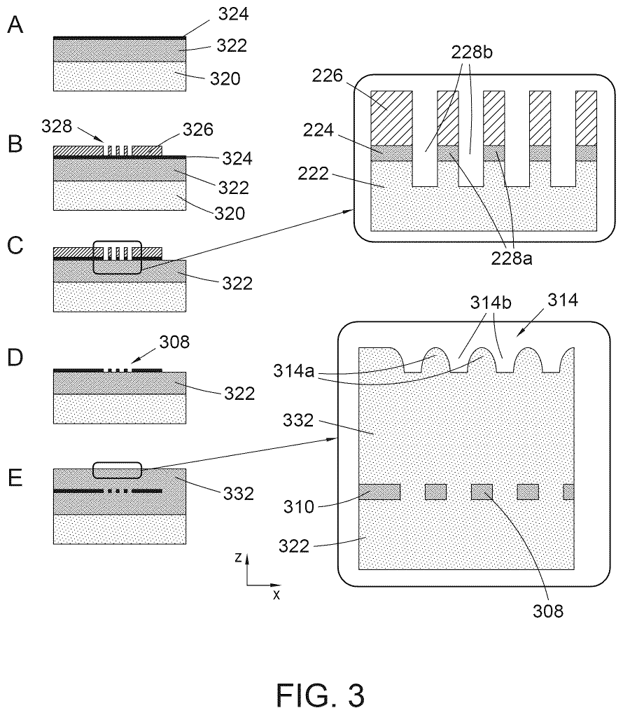

FIG. 3 schematically depicts an alternative method of fabricating the semiconductor device of the module depicted in FIG. 1; and

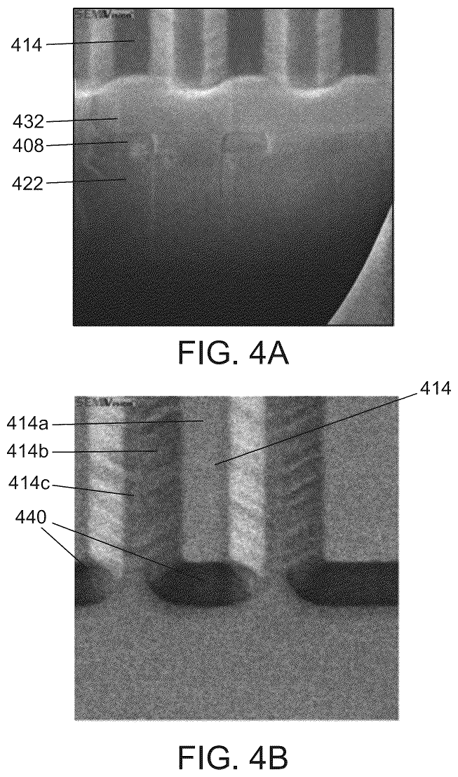

FIG. 4 is scanning electron microscope pictures of part of a semiconductor device according to an embodiment of the disclosure.

### DETAILED DESCRIPTION OF THE PREFERRED EMBODIMENTS

Generally speaking, the disclosure provides an optical module and a method of making an optical module. A grating is formed on the surface of a semiconductor device of the optical module. The grating prevents or reduces back-reflection of light into an emitter of the optical module.

Some examples of the solution are given in the accompanying figures.

FIG. 1 schematically depicts in cross section an optical module 2 which comprises a vertical cavity surface emitting laser (VCSEL) 4 attached to a semiconductor device 6 (only part shown). The semiconductor device 6 includes a grating 8 and a waveguide 10, and may include other elements (as explained further below). The grating 8 has a pitch which is configured to receive light emitted from the VCSEL 4 and couple that light into the waveguide 10. The pitch of the grating 8 is described further below. The VCSEL 4 is attached to the semiconductor device 6. In the depicted optical module the attachment is via bonds 12 which may for example be formed from solder or some other conductor. The semiconductor device 6 may include a driver which is configured to supply power to the VCSEL. A power source may be external to the semiconductor device 6, and for example may be connected to the semiconductor device to form a hybrid assembly. For ease of description, FIG. 1 and other figures include Cartesian coordinates. This is not intended to imply that the optical module 2 must have any particular orientation.

The semiconductor device 6 may extend further in the x-direction, as indicated by dashed lines. The waveguide 10 may be configured to guide light to other elements of the semiconductor device 6 (not depicted). The other elements may for example be one or more sensors, detectors, interferometers, optical switches, spatial light modulators and/or optical logic gates, etc. The semiconductor device 6 may be configured for example for use in telecommunications (e.g. configured to operate at a wavelength used in telecommunications such as 1.5 μm). The semiconductor device may be configured for example for use in optical computing (e.g. including optical logic gates). The optical module 2 may be referred to as a photonic integrated circuit (PIC) because it guides or manipulates light in a structure which may also include integrated electrical circuits and at least one electro-optic device.

An additional grating 14 is provided on the surface of the semiconductor device (above the grating 8 which is configured to couple the light into the waveguide 10). In order to distinguish between the two gratings of the optical module 2, the grating 14 on the surface of the semiconductor device is referred to as the surface grating 14, and the grating 8 which couples light into the waveguide 10 is referred to as the coupling grating 8. The surface grating 14 faces the VCSEL 4. The surface grating 14 may be oriented such that light emitted from the VCSEL 4 is normally incident (or substantially normally incident) upon the surface grating.

There is a gap 16 between the VCSEL 4 and the semiconductor device 6. The gap 16 may for example be between 5 and 50 μm (i.e. a separation between the VCSEL and the semiconductor device 6 may be between 5 and 50 μm). The gap may for example contain air (or some other gas). The semiconductor of the semiconductor device 6 has a considerably higher refractive index than air (or other gas). The VCSEL 4 is configured to emit laser light (e.g. infrared light) from its bottom surface, i.e. towards the semiconductor device 6 (in the −z direction). In other words, the VCSEL 4 faces a surface of the semiconductor device 6. The light emitted by the VCSEL 4 is schematically depicted by the arrow 15. Because there is a step-change of refractive index between the gap 16 and the semiconductor device 6, some of the light emitted from the VCSEL 4 will be reflected from the surface of the semiconductor device.

If the surface grating 14 was not present then the reflected light would be reflected perpendicularly to the semiconductor device surface and would travel back into the VCSEL 4. This is undesirable because the back-reflection of laser light into the VCSEL 4, specifically into a laser cavity of the VCSEL, would interfere with light inside the laser cavity of the VCSEL and cause sub-optimal operation of the VCSEL. The optical performance of the VCSEL would be degraded, and over time the VCSEL would become damaged. This damage could be so severe that the photonic integrated circuit (PIC) ceases to function correctly.

Advantageously, the surface grating 14 diffracts light from the VCSEL 4 which is incident upon the semiconductor device 6. As a result, light which is reflected from the surface of the semiconductor device 6 does not travel back into the VCSEL 4. The reflected light is instead diffracted at an angle which lies outside of an entrance aperture of the VCSEL (specifically the laser cavity of the VCSEL), and so does not travel back into the VCSEL. This advantageously avoids instability in the operation of the VCSEL through back-reflected light, and avoids degradation of the performance of the VCSEL due to back-reflected light. In addition, the possibility of back-reflected light causing severe damage which prevents the photonic integrated circuit (PIC) functioning correctly is avoided. Diffracted reflected light is schematically depicted by arrow 17.

Light which is transmitted through the surface of the semiconductor device 6 is also diffracted by the surface grating 14. This transmitted diffracted light is schematically depicted by arrow 18. The transmitted diffracted light is incident upon the coupling grating 8. The coupling grating couples the light into the waveguide 10. This light is then coupled by the coupling grating 8 into the waveguide 10. Light propagating in the waveguide 10 is schematically depicted by arrow 19.

The surface grating 14 and the coupling grating 8 have the same pitch. The transmitted diffracted light schematically depicted by arrow 18 may be first order diffracted light. The coupling grating 8 receives this first order diffracted light and couples the light into the waveguide 10.

Advantageously, the surface grating 14 is formed through deposition of semiconductor material on top of the coupling grating 8.

The coupling grating 8 is a structure which comprises a series of raised portions separated by spaces (which may be referred to as lower portions). The raised portions and lower portions may be referred to as lines and spaces. The height of the raised portions relative to the lower portions may for example be at least 200 nm (and may for example be up to 500 nm. The pitch of the coupling grating 8 may for example be between 0.5 μm and 1 μm. A ratio of raised portions to lower portions (which may be referred to as a line-space ratio) may for example be between 0.4 and 0.6. These values may be varied depending upon the wavelength of light emitted by the VCSEL and other parameters of the light. The coupling grating 8 may for example have an area (viewed from above) of around 50×50 μm. In general, the coupling grating 8 may have an area of at least 1000 μm².

The semiconductor material is deposited on top of the coupling grating structure. If the deposited semiconductor material is evenly distributed, a thickness of the material deposited on a raised portion of the coupling grating structure may be substantially the same as a thickness of the material deposited on a lower portion of the grating structure. This means that, even when the coupling grating structure has been fully covered by semiconductor material, an upper surface of the covering of semiconductor material still has a grating structure. This grating may be thought of as a projection of the coupling grating, and may be present even when a considerable thickness of semiconductor material covering has been provided (e.g. a thickness which is greater than a height of the coupling grating). The projection of the coupling grating may be present when a thickness of semiconductor material of 1 μm or more (e.g. up to 5 μm) has been provided on top of the coupling grating 8.

In FIG. 1, the projection of the coupling grating 8 in the surface of the covering of semiconductor material is the surface grating 14. The surface grating has a pitch which corresponds with the pitch of the coupling grating. In addition, the surface grating is aligned with the coupling grating (i.e. located directly over the coupling grating). This advantageously avoids the need to ensure alignment between separately implemented coupling and surface gratings (which could be difficult and expensive to achieve in practice).

FIG. 2 schematically depicts formation of an optical module having a coupling grating and a surface grating according to an embodiment of the disclosure. Referring first to FIG. 2A, a silicon substrate 220 is provided, and a layer of SiO₂ 222 is deposited onto the silicon substrate. A layer of SiN 224 is deposited on top of the SiO₂ layer 222. The SiN layer 224 will form a coupling grating and a waveguide when the optical module has been completed (SiN has a higher refractive index than SiO₂).

A layer of resist 226 is applied on top of the SiN layer 224. A lithographic exposure is then performed using a mask. The mask blocks light from being incident on some areas of the resist 226 but allows light to be incident upon other areas of the resist. Where the light is incident upon the resist this causes the resist to undergo a chemical reaction (this may be cross linking caused by exposure to the lithographic light). The resist is then developed to fix the exposed pattern into the resist. Following this, unexposed resist is removed. This lithographic process is well known and so is not described further here. Variations of the lithographic process may be used.

FIG. 2B depicts the result of performing a lithographic exposure, developing exposed resist and removing unexposed resist. As may be seen, a grating structure 228 is formed in the resist 226. Lines of grating structure 228 are generally rectangular. Lines of the grating structure 228 have substantially vertical sides. The grating structure 228 may extend partially across the surface of the SiN layer 224 (i.e. in the y-direction). That is, the grating structure 228 may end before it reaches sides of the SiN layer 224. To form the waveguide, a line of resist 229 which extends in the x-direction is provided. Either side of the line of resist no resist is provided. The patterned developed resist may be referred to as an etch mask.

As depicted in FIG. 2C, an etching process is used such as reactive ion etching (RIE). The etching is capable of etching into the SiN layer 224 but is not capable of etching into the developed resist 226. The etching etches away SiN 224 away at locations which are not protected by the developed resist 226. This is depicted in an expanded view of part of FIG. 2C. Spaces 228b have been formed in the SiN layer 224 by the etching. These spaces 228b together with the remaining SiN 228a form a grating. To the left of the grating, a line of SiN 224 may be seen. This will form part of the waveguide.

As depicted in FIG. 2D, the developed resist is removed from the SiN layer 224. This may be referred to as etch mask stripping. This leaves behind a SiN grating 208 sitting on top of the SiO₂ layer 222. A waveguide 210 is also formed, the waveguide being a line of SiN which extends in the x-direction.

Referring to FIG. 2E, a layer of SiO₂ 232 is deposited on top of the SiN layer 224. The layer of SiO₂ 232 covers the grating 208 and the waveguide 210. The grating 208 is a coupling grating which acts to couple light into the waveguide 210. As explained further above, depositing the SiO₂ onto the grating 208 covers the grating but a projection of the grating remains in the form of a surface grating 214. This is depicted in an expanded view of part of FIG. 2E. The surface grating 214 comprises raised portions 214a separated by spaces 214b (which may also be referred to as lower portions 214b). The surface grating 214 has the same pitch as the coupling grating 228 and is aligned with the coupling grating. The shape of the raised portions 214a of the surface grating 214 is not rectangular like the coupling grating 228. This is due to natural properties of the deposited SiO₂ 232. Properties of the surface grating 214 may be influenced via control of the manner in which deposition of the SiO₂ is performed (as explained further below).

The line of SiN which extends in the x-direction forms the waveguide 210. The SiO₂ layers 222, 232 form upper and lower cladding layers for the SiN core 224 of the waveguide 210 (and also provide cladding on either side of the waveguide). The SiO₂ cladding around the SiN core has a lower refractive index than the SiN, such the core and cladding in combination form the waveguide 210 (they provide wave-guiding of light). For simplicity of description the term waveguide 210 may be used in connection with the SiN core of the waveguide.

In a further step (not depicted), a VCSEL is bonded onto the SiN 232 to form an optical module (as depicted in FIG. 1).

Deposition of material may be performed using chemical vapour deposition (CVD), for example plasma-enhanced chemical vapour deposition (PECVD). Deposition of SiO₂ may be performed using a conventional PECVD recipe such as the following:

| | | |
|---|---|---|
| Temperature | 350° | C. |
| Semiconductor material | 10% SiH4/He - 50 | sccm |
| First gas | N₂O - 710 | sccm |
| Second gas | N₂ - 90 | sccm |
| Pressure | 1000 | mTorr |
| Radio frequency power | 20 | W |

Other recipes may be used.

FIG. 3 schematically depicts an alternative fabrication method which may be used for embodiments of the disclosure. Some steps of this method correspond with steps of the method described above in connection with FIG. 2, and so are not described again in connection with FIG. 3.

In the method of FIG. 3, a silicon substrate 320, an SiO₂ layer 322 and an SiN layer 324 are all formed as described above (see FIG. 3A). Furthermore, resist 326 is formed on the SiN layer 324 as described above and a mask is used in the same way to selectively expose areas of the resist (see FIG. 3B) thereby forming a grating structure 328. Lines of the grating structure 328 are generally rectangular. Lines of the grating structure 328 have substantially vertical sides.

However, referring to FIG. 3C when etching is performed, the etching is performed for a longer period of time than in the method depicted in FIG. 2. As a result, the etching does not merely etch away the SiN 324 but continues and etches into the SiO₂ 322 underneath the SiN. This is schematically depicted in FIG. 3C. In an expanded view of part of FIG. 3C it can be seen that spaces 328b have been etched in the SiN layer 324 and etched into the underlying SiO₂ 322. These spaces 228b together with the remaining SiN 328a and remaining SiO₂ 328c form a grating structure.

FIG. 3D corresponds with FIG. 2D in that the developed resist is removed, leaving behind a grating 308.

FIG. 3E depicts deposition of the upper cladding layer SiO₂ 332. This deposited SiO₂ fills spaces 328b between raised portions of the grating 308. The deposited SiO₂ is also deposited on raised portions 328a of the grating 308 (i.e. onto the SiN of the grating).

Consequently, the spaces are filled and at the same time raised portions between the spaces are raised higher. Thus, a projection of the grating 308 (which may be referred to as a coupling grating) is present in the surface of the upper SiO₂ layer. This projection of the grating is a surface grating 314. As with the embodiment described above, a waveguide 310 is also formed.

The raised portions 314a of the grating are separated by deeper spaces 314b (or lower portions) than the embodiment described above. This is because the etching into SiO₂ provided a deeper initial grating structure 328. However, the coupling grating 308 has the same depth as the embodiment described above. This is because the depth of the coupling grating 308 depends solely on the thickness of the SiN layer 324 (which has not changed). The same applies for the height of the waveguide 310

When the SiO₂ is deposited onto the coupling grating 308, the height difference between the top and bottom of the surface grating formed in the SiO₂ is greater than is seen where the embodiment described further above is used. This is schematically depicted in the enlarged view of FIG. 3E, in which it can be seen that the depth of the surface grating 314 is significantly greater than the depth of the surface grating 214 depicted in FIG. 2E.

FIG. 4 is a pair of scanning electron microscope (SEM) images which show part of a semiconductor device formed according to an embodiment of the invention. In common with the embodiments described above, SiO₂ and SiN were used. Deposition of material was via plasma enhanced chemical vapour deposition (PECVD), and the etching was reactive ion etching (RIE). Referring first to FIG. 4A, a cross-section has been taken in the plane depicted in FIGS. 2 and 3, and the SEM image has been taken at a 45 degree angle to the cross-section. A coupling grating 408 formed from SiN surrounded by SiO₂ 422, 432 can be seen. In addition, a surface grating 414 can be seen. The surface grating 414 has the same pitch as the coupling grating 408 and is aligned with the coupling grating.

FIG. 4B shows the surface grating 414 viewed from above at a 45 degree angle. Ends 440 of the surface grating 414 can be seen. These ends correspond in position with ends of the coupling grating (not visible).

Referring to FIGS. 4A and 4B in combination, the coupling grating 408 has a generally rectangular structure but the surface grating 414 does not have a generally rectangular structure. The surface grating 414 instead comprises a series of elongate raised portions with flat upper surfaces 414a and sloped side surfaces 414b that meet flat lower surfaces 414c. These grating configurations are advantageous. In particular, vertical (or substantially vertical) sidewalls of the generally rectangular coupling grating 408 provide the most effective coupling of light into an adjacent waveguide (not depicted). Sloped side surfaces of the surface grating 414b provide diffuse reflection of light in non-normal directions (i.e. not in the direction of a VCSEL cavity located above the surface grating).

In general, the surface grating of an embodiment of the invention may be provided with sloped side surfaces. As noted above, this may advantageously direct any diffuse reflection of light away from the emitter (e.g. VCSEL). The sloping side surfaces of the surface grating may occur naturally due to the way in which material accumulates on a coupling grating (e.g. when PECVD is used). For example, the sloping side surfaces may be formed when using the SiO₂ PECVD recipe set out further above.

Although the above described embodiments of the disclosure have used SiN, other materials such as Si may be used. GaAs compatible materials such as AlGaAs, GaSbAs, etc. may be used. In a further alternative, InP and compatible materials such as InGaAs, InAlGaAs, and GaN may be used. As mentioned further above, the substrate may be formed from Si. However, other materials may be used to form the substrate such as glass, sapphire, GaAs, etc.

The above described embodiments of the disclosure all have a VCSEL. However, this is merely an example of an emitter that may be used, and a different emitter may be used. One example of an alternative emitter that may be used is an edge emitting semiconductor laser. In general, any suitable emitter may be used. The emitter may be an infrared emitter (i.e. configured to emit infrared light). The emitter may for example be configured to emit at or around 850 nm, or at a wavelength in the range 1530 nm-1565 nm (e.g. 1550 nm) The emitter may be configured to emit at a non-infrared wavelength.

References to a waveguide may be interpreted as meaning an elongate portion of material of a first semiconductor which is surrounded by a second semiconductor, the first semiconductor having a higher refractive index than the second semiconductor and having a cross-sectional size which is configured to guide light at a known wavelength or wavelength range. A core of the waveguide may for example have a cross-section of 0.2×0.6 μm or larger. A core of the waveguide may for example have a cross section of 0.5×1 μm or less.

References to a diffraction grating may be interpreted as meaning a series of lines and spaces with a regular pitch. The pitch of the grating may be selected with reference to the wavelength of incident light in order to obtain a desired angle of diffraction.

In embodiments of the invention lines of the coupling grating may be generally rectangular in cross-section. In embodiments of the invention lines of the coupling grating may have substantially vertical sides. In embodiments of the invention lines of the surface grating may have sloping sides.

In this document there are references to the surface grating being a “projection” of the coupling grating. This may be interpreted as meaning that that the structure of the grating has projected through (i.e. remains present on) the SiO₂ (or other semiconductor material) such that a corresponding grating is present on the surface of the semiconductor material. The corresponding grating (the surface grating) may not have lines with the same cross-sectional shape as the coupling grating, but has the same pitch as the coupling grating and is located above the coupling grating. The surface grating may be aligned with the coupling grating.

In described embodiments of the invention the surface grating is aligned with the coupling grating. Alignment of the gratings may be achieved when deposition of material onto the coupling grating does not use directed deposition (i.e. uses undirected deposition). If directed deposition is used then an offset of the surface grating relative to the coupling grating may be introduced.

In embodiments of the invention, the surface grating is a different grating to the coupling grating. The surface grating may be referred to as an additional grating.

### LIST OF REFERENCE NUMERALS

| | |
|---|---|
| 2 | Optical module |
| 4 | Vertical cavity surface emitting laser (VCSEL) |
| 6 | Semiconductor device |
| 8 | Coupling grating |
| 10 | Waveguide |
| 12 | Bonds |
| 14 | Surface grating |
| 15 | Light emitted by VCSEL |
| 16 | Gap |
| 17 | Diffracted reflected light |
| 18 | Diffracted transmitted light |
| 19 | Light propagating in waveguide |
| 208 | Grating (coupling grating) |
| 210 | Waveguide |
| 214 | Grating (surface grating) |
| 214a | Raised portions of grating structure |
| 214b | Lowered portions of grating structure |
| 220 | Silicon substrate |
| 222 | SiO₂ layer |
| 224 | SiN layer |
| 226 | Resist |
| 228 | Grating structure |
| 228a | Raised portions of grating structure |
| 228b | Spaces of grating structure |
| 229 | Line of resist |
| 232 | Layer of SiO₂ |
| 308 | Grating (coupling grating) |
| 310 | Waveguide |
| 314 | Grating (surface grating) |
| 314a | Raised portions of grating structure |
| 314b | Lowered portions of grating structure |
| 320 | Silicon substrate |
| 322 | SiO₂ layer |
| 324 | SiN layer |
| 326 | Resist |
| 228 | Grating structure |
| 328a | SiN of grating structure |
| 328b | Spaces of grating structure |
| 328c | SiO₂ of grating structure |
| 332 | Layer of SiO₂ |
| 414 | Grating (surface grating) |
| 414a | Upper surface of surface grating |
| 414b | Side surface of surface grating |
| 414c | Lower surface of surface grating |
| 422 | SiO₂ |
| 432 | SiO₂ |
| 440 | Ends of surface grating |

The skilled person will understand that in the preceding description and appended claims, positional terms such as ‘above’, ‘along’, ‘side’, uppermost, lowermost, top, bottom, etc. are made with reference to conceptual illustrations, such as those shown in the appended drawings. These terms are used for ease of reference but are not intended to be of limiting nature. These terms are therefore to be understood as referring to an object when in an orientation as shown in the accompanying drawings.

Although the disclosure has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in any embodiments, whether alone or in any appropriate combination with any other feature disclosed or illustrated herein.

1. An optical module comprising an emitter and a semiconductor device, the emitter being attached to the semiconductor device and being separated from the semiconductor device by a gap, wherein the semiconductor device comprises a waveguide and a diffraction grating located within semiconductor of the semiconductor device, the diffraction grating being a coupling diffraction grating configured to couple light emitted from the emitter into the waveguide, and wherein the semiconductor device further comprises an additional diffraction grating which is provided on a surface of the semiconductor device which faces the emitter.

2. The optical module of claim 1, wherein the diffraction grating on the surface of the semiconductor device has the same pitch as the coupling diffraction grating.

3. The optical module of claim 1, wherein the diffraction grating on the surface of the semiconductor device is aligned with the coupling diffraction grating.

4. The optical module of claim 1, wherein the diffraction grating on the surface of the semiconductor device is a projection of the coupling diffraction grating to the surface of the semiconductor device.

5. The optical module of claim 1, wherein raised portions of the diffraction grating on the surface of the semiconductor device have sloping sides.

6. The optical module of claim 1, wherein lines of the coupling diffraction grating have substantially vertical sides.

7. The optical module of claim 1, wherein the emitter is a laser.

8. The optical module of claim 7, wherein the emitter is a vertical cavity surface emitting laser.

9. The optical module of claim 1, wherein the emitter is configured to emit infrared light.

10. The optical module of claim 1, wherein the semiconductor device comprises a first semiconductor material and a second semiconductor material, the first semiconductor material having a higher refractive index than the second semiconductor material, wherein the coupling diffraction grating and the waveguide are formed from the first semiconductor material encased in the second semiconductor material, and wherein the diffraction grating on the surface of the semiconductor device is formed from the second semiconductor material.

11. The optical module of claim 10, wherein the first semiconductor material is SiN and the second semiconductor material is SiO₂.

12. The optical module of claim 1, wherein the semiconductor device further comprises integrated circuits and at least one electro-optic device.

13. A method of forming an optical module comprising:
providing a layer of a second semiconductor material on top of a layer of a first semiconductor material;
using lithography to etch a pattern into the second semiconductor material, the pattern comprising a coupling diffraction grating and a waveguide;
using a deposition process to provide more of the first semiconductor material on top of the diffraction grating and waveguide, wherein an additional diffraction grating is formed on an upper surface of the first semiconductor surface, this surface diffraction grating being a projection of the coupling diffraction grating; and
attaching an emitter to the semiconductor device, the emitter being separated from the semiconductor device by a gap.

14. The method of claim 13, wherein the etching passes through the second semiconductor material and etches into the first semiconductor material.

15. The method of claim 13, wherein the surface diffraction grating has the same pitch as the coupling diffraction grating.

16. The method of claim 13, wherein the surface diffraction grating is aligned with the coupling diffraction grating.

17. The method of claim 13, wherein raised portions of the surface diffraction grating have sloping sides.

18. The method of claim 13, wherein lines of the coupling diffraction grating have substantially vertical sides.

19. The method of claim 13, wherein the first semiconductor material is SiN and the second semiconductor material is SiO₂.
